(19) United States
(12) Patent Application Publication
(10) Pub. No.: US 2009/0117770 A1
(43) Pub. Date: May 7, 2009

(54) CONNECTOR

(75) Inventors: Masayuki FUKUI, Shizuoka (JP); Terufumi HARA, Shizuoka (JP); Masahito KAZUNO, Shizuoka (JP)

Correspondence Address: SUGHRUE-265550, 2100 PENNSYLVANIA AVE. NW, WASHINGTON, DC, 20037-3213, US

(73) Assignee: YAZAKI CORPORATION, Tokyo (JP)

(21) Appl. No.: 12/261,740

(22) Filed: Oct. 30, 2008

(30) Foreign Application Priority Data
Nov. 1, 2007 (JP) 2007-284748

(51) Int. Cl. H01R 13/62

(52) U.S. Cl. 439/345

(57) ABSTRACT

When a male connector housing 30 is inserted into a proximal end portion of an inner surface 37 of a fitting tubular portion 33, a distal end 45 of an outer surface 41 of the male connector housing 30 is brought into abutting engagement with a plurality of first shaking prevention portions 25 formed at the proximal end portion of this inner surface 37. At this time, a distal end 46 of an inner surface 37 of the fitting tubular portion 33 is also brought into abutting engagement with a plurality of second shaking prevention portions 26 formed at a proximal end portion of the outer surface 41 of the male connector housing 30. Thereafter, a force slightly larger than the insertion force applied so far is applied to the connector, so that press-fitted conditions are formed respectively at the first shaking prevention portions 25 and the second shaking prevention portions 26.

### BACKGROUND OF THE INVENTION

1. Field of the Invention

This invention relates to a connector in which shaking prevention portions for preventing a shaking movement are formed on connector housings.

2. Description of the Related Art

Patent Literatures 1 and 2 mentioned below disclose a connector in which shaking prevention portions (slight movement prevention portions) for preventing a shaking movement are formed on a connector housing. This connector will now be described with reference to FIGS. 8 and 9. In FIGS. 8 and 9, a female connector housing 1 has a fitting tubular portion 3 into which a male connector housing 2 is inserted and fitted. A plurality of shaking prevention portions 4 for holding the male connector housing 2 in a press-fitted condition are formed on an inner surface (inner peripheral surface) of the fitting tubular portion 3.

The shaking prevention portions 4 extend long from an open end edge of the fitting tubular portion 3 to an inner wall thereof. Each shaking prevention portion 4, when viewed from the front side, has a generally trapezoidal shape. Each shaking prevention portion 4 is hard such that the whole thereof has a sufficient rigidity. The plurality of shaking prevention portions 4 are provided for preventing the shaking of the male connector housing 2 fitted in the fitting tubular portion 3. Each shake prevention portion 4 projects from the inner surface of the fitting tubular portion 3 in an amount slightly larger than a clearance between the fitting tubular portion 3 and the male connector housing 2. The shaking prevention portions 4 are formed respectively at four portions of the inner surface of the fitting tubular portion 3 as shown in FIG. 8 and 9.

Reference numeral 5 denote fitting guide ribs formed on the male connector housing 2, reference numeral 6 denote guide rib guide grooves for respectively guiding the fitting guide ribs 5, reference numeral 7 denotes a lock arm formed on the male connector housing 2, and reference numeral 8 denotes a lock portion for locking engagement with the lock arm 7. As can be seen from FIGS. 8 and 9, the shaking prevention portions 4 are formed respectively on those portions of the fitting tubular portion 3 at which the guide rib guide groove 6 and the lock portion 8 are not formed.

In the above structure, when the male connector housing 2 is inserted and fitted into the fitting tubular portion 3 of the female connector housing 1,the male connector housing 2 is held in a press-fitted condition relative to the fitting tubular portion 3 because of the provision of the shaking prevention portions 4.

As a result, the shaking of the two connector housings fitted together is prevented. When the shaking of the male connector housing 2 is prevented, a connected condition of male and female metal terminals will not be adversely affected. Also, the generation of an abnormal sound can be suppressed.

Patent Literature 1: JP-A-2004-296452

Patent Literature 2: JP-A-2002-198127

In the above conventional techniques, the shaking prevention portions 4 formed on the fitting tubular portion 3 project in an amount slightly larger than the clearance between the fitting tubular portion 3 of the female connector housing 1 and the male connector housing 2, and therefore there has been encountered a problem that an insertion force required for inserting and fitting the male connector housing 2 into the fitting tubular portion 3 is high from the start of this fitting operation. And besides, since such high insertion force is required, the male connector housing 2 must be pushed or forced hard into the fitting tubular portion 3 at the time of effecting the fitting operation, and this invites a problem that the shaking prevention portions 4 may be shaved, depending on the magnitude and direction of this pushing force. The shaking prevention portions 4, when thus shaved, can not sufficiently perform the shaking prevention function.

### SUMMARY OF THE INVENTION

This invention has been made in view of the above problem, and an object of the invention is to provide a connector in which an insertion force required for a connector fitting operation can be reduced, and the shaking of connector housings fitted together can be prevented.

The above object has been achieved by a connector of the first aspect of the invention comprising a female connector housing having a fitting tubular portion, and a male connector housing which is inserted and fitted into the fitting tubular portion, wherein a plurality of shaking prevention portions for preventing the shaking of the female and male connector housings fitted together are formed on an inner surface of the fitting tubular portion; characterized in that the shaking prevention portions include a plurality of first shaking prevention portions formed on a proximal end portion of the inner surface of the fitting tubular portion, and a plurality of second shaking prevention portions formed on a proximal end portion of an outer surface of the male connector housing.

The connector of the second aspect of the invention, depending from the first aspect of the invention, is characterized in that each of the first shaking prevention portions, as well as each of the second shaking prevention portions, is formed into a rib-like shape, and extends in a direction parallel to a direction of fitting of the female and male connector housings to each other, and a length of each first shaking prevention portion and a length of each second shaking prevention portion are so determined that the press-fitting of a distal end of the outer surface of the male connector housing to the first shaking prevention portions can begin generally simultaneously with the press-fitting of a distal end of the inner surface of the fitting tubular portion to the second shaking prevention portions.

The connector of the third aspect of the invention, depending from the first aspect of the invention, is characterized in that a tapering surface for guide purposes is formed on each of the first shaking prevention portions, and a tapering surface for guide purposes is formed on each of the second shaking prevention portions.

In the present invention having the above features, when the connector fitting operation is started, the male connector housing is inserted into the fitting tubular portion of the female connector housing. As the insertion of the male connector housing proceeds, male metal terminals are inserted into respective female metal terminals, and therefore begin to be electrically connected thereto. Then, when the male connector housing is further inserted into the proximal end portion of the inner surface of the fitting tubular portion, the distal end of the outer surface of the male connector housing is brought into abutting engagement with the plurality of first shaking prevention portions formed at the proximal end portion of this inner surface. At this time, the distal end of the inner surface of the fitting tubular portion is also brought into abutting engagement with the plurality of second shaking prevention portions formed on the proximal end portion of the outer surface of the male connector housing. When a force (insertion force) slightly larger than the insertion force applied so far is applied to the connector immediately before the end of the connector fitting operation, press-fitted conditions are formed respectively at the first shaking prevention portions and the second shaking prevention portions.

In the present invention, the press-fitted conditions are formed at a plurality of pairs of front and rear regions of the connector, each pair of front and rear regions being spaced from each other in the connector fitting direction. Therefore, the shaking of the two connector housings fitted together can be more positively prevented. Furthermore, in the present invention, only a relatively small insertion force need to be applied until immediately before the end of the connector fitting operation, and therefore the efficiency of the operation can be enhanced. Furthermore, in the present invention, the tapering surfaces for guide purposes are formed respectively at the first and second shaking prevention portions, and therefore each connector housing is prevented from being caught by the mating shaking prevention portions (so that the inserting operation will not be adversely affected), and the press-fitted conditions can be smoothly formed at the front and rear regions of the connector spaced from each other in the connector fitting direction, that is, are formed respectively at the first shaking prevention portions and the second shaking prevention portions. Therefore, the efficiency of the operation can be enhanced.

When this invention is applied to a lever-fitting type connector (for example, an LIF (low insertion force) connector) in which an insertion force is reduced by the provision of a lever, this is more effective.

In the invention of the first aspect of the invention, there is achieved an advantage that the insertion force required for fitting the two connector housings together can be kept to a level lower than that required for the conventional structures until immediately before the end of the fitting operation. In the invention, there is also achieved an advantage that the shaking of the connector housings fitted together can be more positively prevented as compared with the conventional structures.

In the second aspect of the invention, the press-fitted conditions are formed simultaneously at the front and rear regions of the connector, and therefore there is achieved an advantage that the fitting operation can be effected while using a relatively small insertion force until immediately before the end of the connector fitting operation.

In the third aspect of the invention, because of the provision of the tapering surfaces, the press-fitted conditions can be smoothly formed respectively at the front and rear regions of the connector.

### BRIEF DESCRIPTION OF THE DRAWINGS

FIG. 1 is a cross-sectional view of one preferred embodiment of a connector of the invention, showing a connector fitting process.

FIG. 2 is an enlarged view of a portion A of FIG. 1.

FIG. 3A is a front-elevational view of a female connector housing, and

FIG. 3B is a front-elevational view of a male connector.

FIG. 4 is a cross-sectional view of the connector in its fitted condition.

FIG. 5 is an enlarged view of a portion B of FIG. 4.

FIG. 6 is a perspective view of the female connector.

FIG. 7 is a cross-sectional view of the female connector.

FIG. 8 is a front-elevational view of a female connector housing of a conventional connector.

FIG. 9 is a cross-sectional view showing a connector-fitted condition of the conventional connector.

### DESCRIPTION OF THE PREFERRED EMBODIMENTS

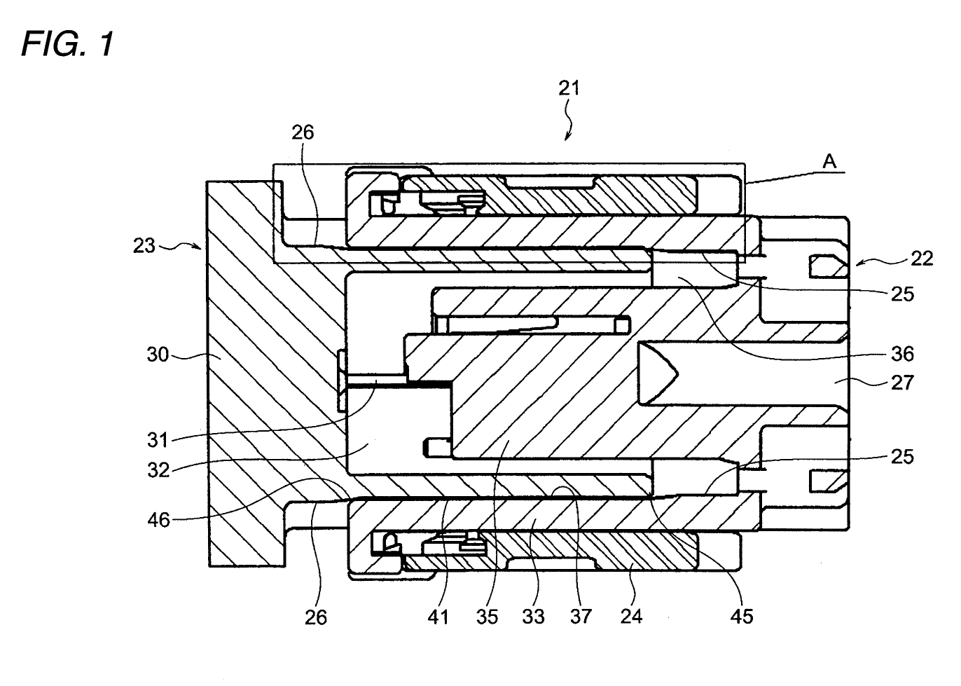

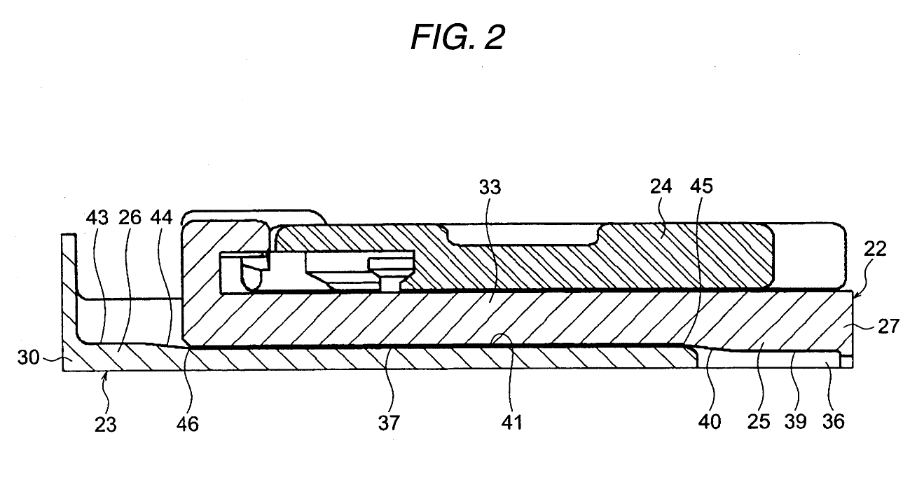

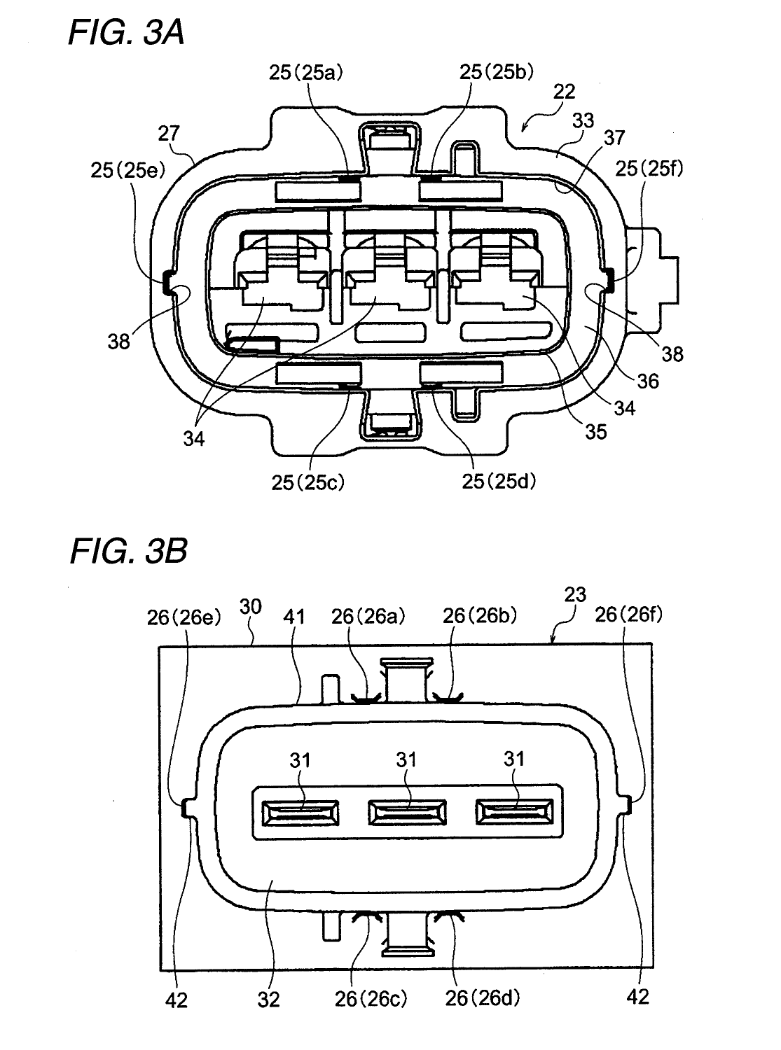

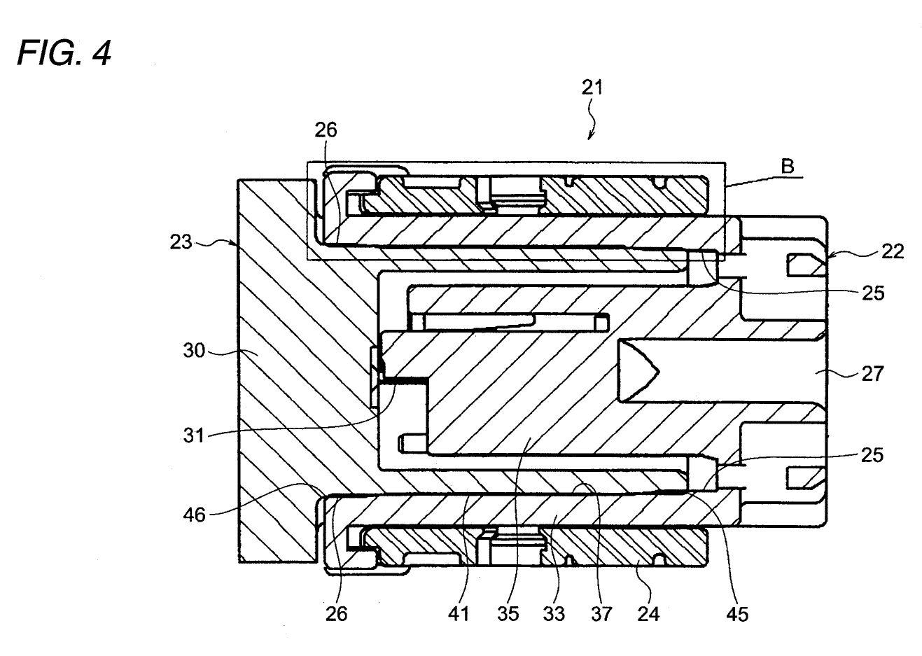

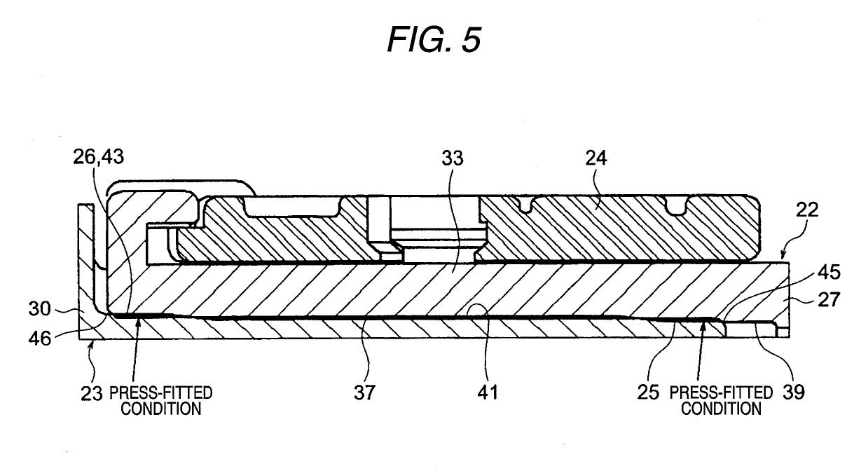

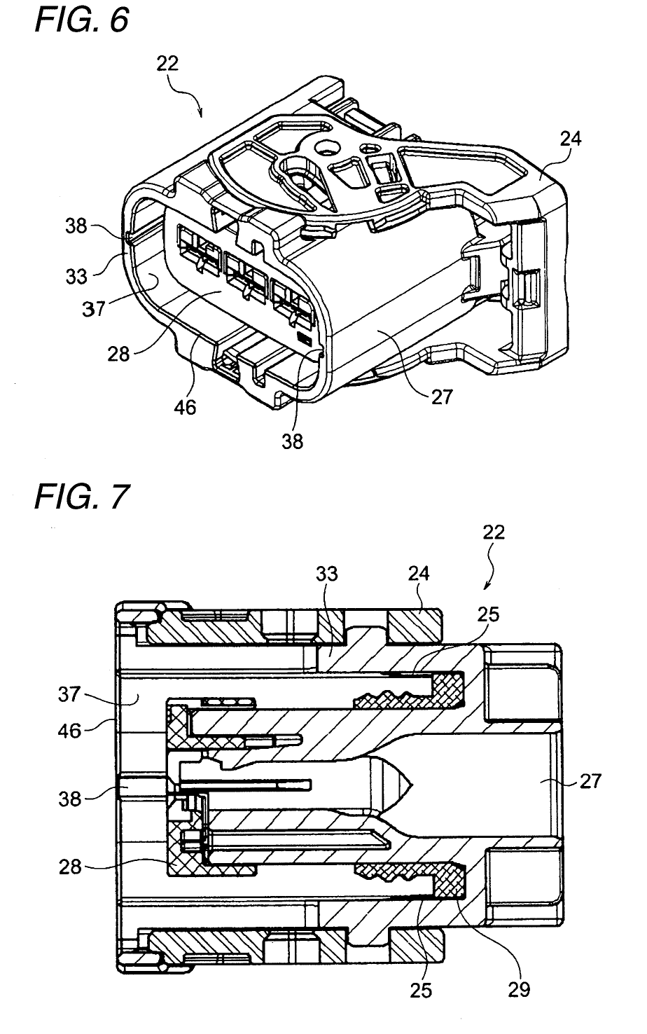

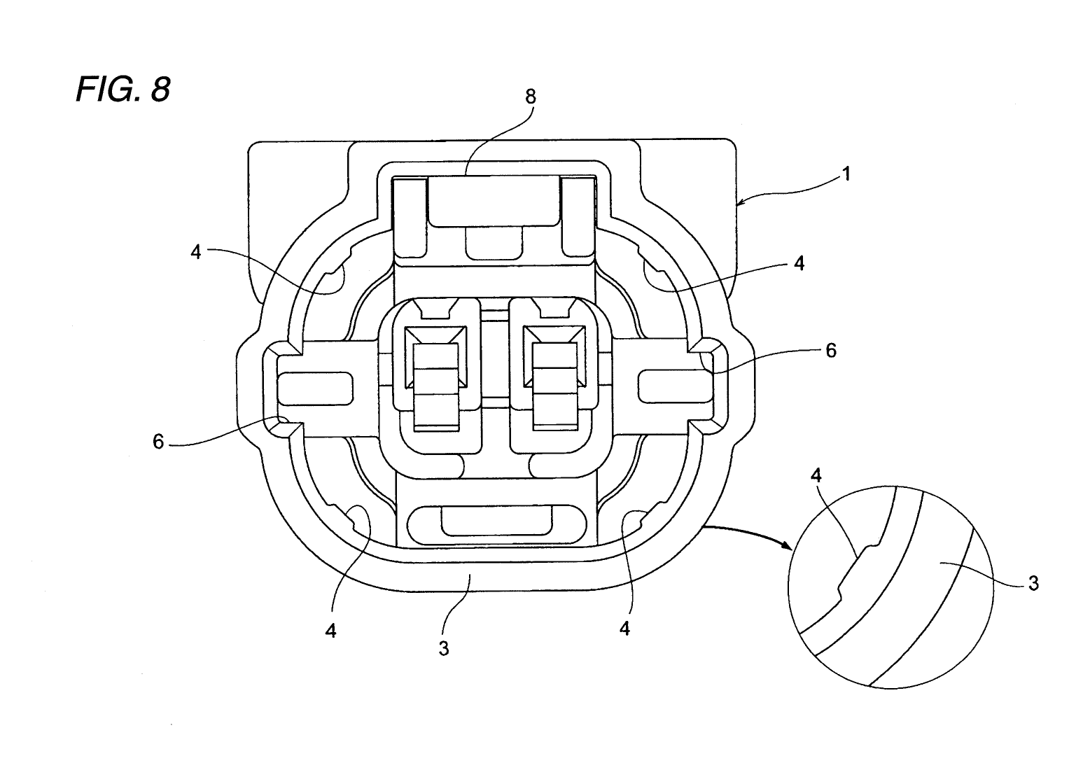

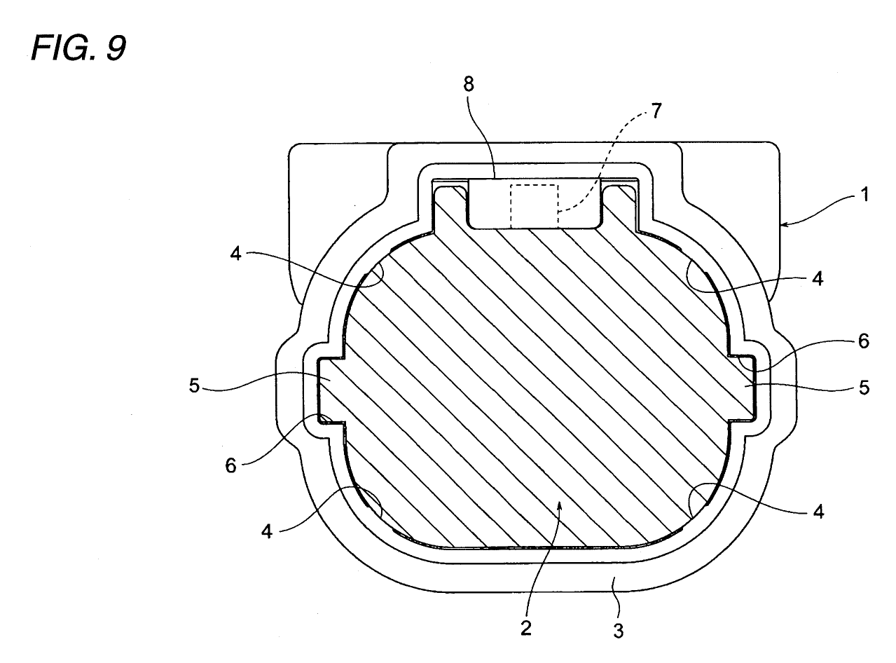

The present invention will now be described with reference to the drawings. FIG. 1 is a cross-sectional view of one preferred embodiment of a connector of the invention, showing a connector fitting process, FIG. 2 is an enlarged view of a portion A of FIG. 1, FIG. 3A is a front-elevational view of a female connector housing, FIG. 3B is a front-elevational view of a male connector, FIG. 4 is a cross-sectional view of the connector in its fitted condition, FIG. 5 is an enlarged view of a portion B of FIG. 4, FIG. 6 is a perspective view of the female connector, and FIG. 7 is a cross-sectional view of the female connector. In some of the above cross-sectional views, the showing of part of constituent members is omitted.

In FIG. 1, the connector 21 comprises the female connector 22, and the male connector 23, and the female and male connectors 22 and 23 are fitted together to be electrically connected together. The connector 21 of this embodiment has a waterproof construction (This is merely one example). In the connector 21, the female connector 22 includes a lever 24, and thanks to the provision of this lever 24, the female connector 22 and the male connector 23 can be fitted together (connected together) with a lower insertion force.

The connector 21 is of such a construction that after the female connector 22 and the male connector 23 are fitted together, a relative slight movement (shaking movement) will not develop between the female connector 22 and the male connector 23. Furthermore, the connector 21 is of such a construction that an insertion force required for fitting the female connector 22 and the male connector 23 together can be kept to a level lower than that required for the conventional structures until immediately before the end of the connector fitting operation. These features are achieved by the provision of first shaking prevention portions 25 at the female connector 22 and also by the provision of second shaking prevention portions 26 at the male connector 23.

The female connector 22 comprises the female connector housing 27 made of an insulative synthetic resin, the lever 24 (see FIG. 6) made of a synthetic resin and pivotally mounted on an outer surface of the female connector housing 27, female metal terminals (not shown) received and retained in respective terminal receiving chambers of the female connector housing 27, a front holder 28 (see FIGS. 6 and 7) made of an insulative resin and fitted to the female connector housing 27 to form front portions of the terminal receiving chambers, and a rubber packing 29 (see FIG. 7) which is held between the female and male connectors 22 and 23 and is elastically deformed in the connector fitting operation, thereby preventing the intrusion of water.

On the other hand, the male connector 23 comprises a male connector housing 30 made of an insulative synthetic resin, and male metal terminals 31 received and retained in respective terminal receiving chambers of the male connector housing 30. Each male metal terminal 31 has an elongated tab-like electrical contact portion projecting into an internal space 32 of the male connector housing 30. The above constituent members are basically similar in function to known ones, and detailed description of the constituent members other than the female and male connector housings 27 and 30 will be omitted here.

In FIGS. 1 and 3A, the female connector housing 27 has a fitting tubular portion 33 (of a tubular shape) for fitting on the male connector 23 (the male connector housing 30). The lever 24 is pivotally mounted on the outer surface (outer peripheral surface) of the fitting tubular portion 33. The female connector housing 27 has an integral terminal receiving portion 35 (which has the plurality of terminal receiving chambers 34) formed within the fitting tubular portion 33. The terminal receiving portion 35 projects into an internal space 36 of the fitting tubular portion 33. An outer surface (outer peripheral surface) of the terminal receiving portion 35 is spaced a predetermined distance from an inner surface (inner peripheral surface) 37 of the fitting tubular portion 33.

In FIGS. 1 to 3A, the plurality of first shaking prevention portions 25 are formed on a proximal end portion of the inner surface 37 of the fitting tubular portion 33. Each first shaking prevention portion 25 has a rib-like shape (or elongated projection-like shape). The first shaking prevention portions 25 are disposed to provide a symmetrical arrangement as described later. In FIG. 3A, the first shaking prevention portions 25 are indicated in solid black for illustration purposes.

In this embodiment, the first shaking prevention portions 25a and 25b are disposed symmetrically with respect to a first median plane (not shown) (passing through a center axis of the fitting tubular portion 33) of the fitting tubular portion 33 disposed in the upward-downward direction in FIG. 3A, and the first shaking prevention portions 25c and 25d are disposed symmetrically with respect to the first median plane, and the first shaking prevention portions 25e and 25f are disposed symmetrically with respect to the first median plane. Also, the first shaking prevention portions 25a and 25c are disposed symmetrically with respect to a second median plane (not shown) (passing through the center axis of the fitting tubular portion 33) of the fitting tubular portion 33 disposed in the right-left direction in FIG. 3A, and the first shaking prevention portions 25b and 25d are disposed symmetrically with respect to the second median plane. The first shaking prevention portions 25e and 25f are disposed on the second median plane (The above arrangement of the first shaking prevention portions 25, as well as the number thereof, is merely one example).

A pair of guide grooves 38 are formed in the inner surface 37 of the fitting tubular portion 33. The first shaking prevention portions 25e and 25f are formed respectively in the pair of guide grooves 38. The guide grooves 38 extend in a direction parallel to the connector fitting direction.

In FIGS. 1 and 2, the first shaking prevention portion 25 includes a press-fitting surface 39 parallel to the connecting fitting direction, and a tapering (or slanting) surface 40 (for guide purposes) continuous with this press-fitting surface 39. In this embodiment, the length of each first shaking prevention portion 25 having the press-fitting surface 39 and the tapering surface 40 is about 20% of the overall length of the fitting tubular portion 33 (but is not always limited to this length.). The press-fitting surface 39 is slightly projected inwardly from the inner surface 37. The tapering surface 40 is gently slanting relative to the press-fitting surface 39.

In FIGS. 1 and 3B, the male connector housing 30 has the internal space 32 into which the terminal receiving portion 35 of the female connector housing 27 is inserted when the connector fitting operation is effected. The electrical contact portions of the plurality of male metal terminals 31 project into this internal space 32 as described above. That portion of the male connector housing 30 having this internal space 32 is formed into a tubular shape, and in the connector fitting operation, this tubular portion is inserted into the internal space 36 of the female connector housing 27.

The plurality of second shaking prevention portions 26 are formed on a proximal end portion of an outer surface (outer peripheral surface)41 of the male connector housing 30. Each second shaking prevention portion 26 has a rib-like shape (or elongated projection-like shape). The second shaking prevention portions 26 are disposed to provide a symmetrical arrangement as described later. The second shaking prevention portions 26 are arranged so as to correspond respectively to the first shaking prevention portions 25 as will hereafter more fully be described. In FIG. 3B, the second shaking prevention portions 26 are indicated in solid black for illustration purposes.

In this embodiment, the second shaking prevention portions 26a and 26b are disposed symmetrically with respect to a first median plane (not shown) (passing through a center axis of the male connector housing 30) of the male connector housing 30 disposed in the upward-downward direction in FIG. 3B, and the second shaking prevention portions 26c and 26d are disposed symmetrically with respect to the first median plane, and the second shaking prevention portions 26e and 26f are disposed symmetrically with respect to the first median plane. Also, the second shaking prevention portions 26a and 26c are disposed symmetrically with respect to a second median plane (not shown) (passing through the center axis of the male connector housing 30) of the male connector housing 30 disposed in the right-left direction in FIG. 3B, and the second shaking prevention portions 26b and 26d are disposed symmetrically with respect to the second median plane. The second shaking prevention portions 26e and 26f are disposed on the second median plane (The above arrangement of the second shaking prevention portions 26, as well as the number thereof, is merely one example).

A pair of guide projections 42 are formed on the outer surface 41 of the male connector housing 30. The second shaking prevention portions 26e and 26f are formed respectively on the pair of guide projections 42. The guide projections 42 each having a generally rail-shape extend in a direction parallel to the connector fitting direction. The guide projections 42 are adapted to be inserted respectively into the guide groove 38 of the female connector housing 27, and can be guided by the respective guide grooves 38.

In FIGS. 1 and 2, the second shaking prevention portion 26 includes a press-fitting surface 43 parallel to the connecting fitting direction, and a tapering (or slanting) surface 44 (for guide purposes) continuous with this press-fitting surface 43. In this embodiment, the length of each second shaking prevention portion 26 having the press-fitting surface 43 and the tapering surface 44 is equal to the length of the first shaking prevention portion 25. The press-fitting surface 43 is slightly projected outwardly from the outer surface 41. The tapering surface 44 is gently slanting relative to the press-fitting surface 43.

In the above construction, when the connector fitting operation is started, the male connector housing 33 is inserted into the fitting tubular portion 33 of the female connector housing 27 as shown in FIGS. 1 and 2. As the insertion of the male connector housing 30 proceeds while using the lever 24, the tab-like electrical contact portions of the male metal terminals 31 are inserted respectively into box-like electrical contact portions of the female metal terminals, so that the male metal terminals 31 thus begin to be electrically connected to the respective female metal terminals.

Then, when the male connector housing 30 is further inserted into the proximal end portion of the inner surface 37 of the fitting tubular portion 33, a distal end 45 of the outer surface 41 of the male connector housing 30 is brought into abutting engagement with the plurality of first shaking prevention portions 25 (that is, the tapering surfaces 40) formed at the proximal end portion of the inner surface 37. At this time, a distal end 46 of the inner surface 37 of the fitting tubular portion 33 is also brought into abutting engagement with the plurality of second shaking prevention portions 26 (that is, the tapering surfaces 44) formed at the proximal end portion of the outer surface 41 of the male connector housing 30.

When a force (insertion force) slightly larger than the insertion force applied so far is applied to the connector immediately before the end of the connector fitting operation (see FIGS. 4 and 5), press-fitted conditions are formed respectively at the first shaking prevention portions 25 and the second shaking prevention portions 26. More specifically, the distal end 45 of the outer surface 41 of the male connector housing 30 slides onto the press-fitting surfaces 39 of the first shaking prevention portions 25, thereby forming the press-fitted conditions of these first shaking prevention portions 25, and at the same time the distal end 46 of the inner surface 37 of the fitting tubular portion 33 slides onto the press-fitting surfaces 43 of the second shaking prevention portions 25, thereby forming the press-fitted conditions of these second shaking prevention portions 26. When the press-fitted conditions are thus formed, with the lever 24 pivotally moved to a predetermined position, the male connector housing 30 is completely inserted in the fitting tubular portion 33, thus completing the connector fitting operation.

As described above with reference to FIGS. 1 to 7, in the present invention, the press-fitted conditions are formed at a plurality of pairs of front and rear regions of the connector, each pair of front and rear regions being spaced from each other in the connector fitting direction. Therefore, the shaking of the two connector housings fitted together can be more positively prevented as compared with the conventional structures.

Furthermore, in the present invention, only a relatively small insertion force need to be applied until immediately before the end of the connector fitting operation, and therefore the efficiency of the operation can be much more enhanced as compared with the conventional structures.

Furthermore, in the present invention, the tapering surfaces 40 for guide purposes are formed respectively at the first shaking prevention portions 25, while the tapering surfaces 44 for guide purposes are formed respectively at the second shaking prevention portions 26, and therefore each connector housing 27, 30 is prevented from being caught by the mating shaking prevention portions 25, 26 (so that the inserting operation will not be adversely affected), and the press-fitted conditions can be smoothly formed at the front and rear regions of the connector spaced from each other in the connector fitting direction, that is, are formed respectively at the first shaking prevention portions 25 and the second shaking prevention portions 26 spaced from the first shaking prevention portions 25 in the connector fitting direction. Therefore, the efficiency of the operation can be further enhanced.

The present invention is not limited to the above embodiment, and various modifications can be made without departing from the subject matter of the invention.

What is claimed is:

1. A connector, comprising:
a female connector housing having a fitting tubular portion; and
a male connector housing which is inserted and fitted into said fitting tubular portion;
wherein a plurality of shaking prevention portions for preventing the shaking of said female and male connector housings fitted together are formed on an inner surface of said fitting tubular portion; and
said shaking prevention portions include a plurality of first shaking prevention portions formed on a proximal end portion of the inner surface of said fitting tubular portion, and a plurality of second shaking prevention portions formed on a proximal end portion of an outer surface of said male connector housing.

2. The connector according to claim 1, wherein:
each of said first shaking prevention portions, as well as each of said second shaking prevention portions, is formed into a rib-like shape, and extends in a direction parallel to a direction of fitting of said female and male connector housings to each other; and
a length of each first shaking prevention portion and a length of each second shaking prevention portion are so determined that the press-fitting of a distal end of the outer surface of said male connector housing to said first shaking prevention portions can begin generally simultaneously with the press-fitting of a distal end of the inner surface of said fitting tubular portion to said second shaking prevention portions.

3. The connector according to claim 1, wherein:
a tapering surface for guide purposes is formed on each of said first shaking prevention portions; and
a tapering surface for guide purposes is formed on each of said second shaking prevention portions.
